(19) United States
(12) Patent Application Publication
(10) Pub. No.: US 2008/0034352 A1
(43) Pub. Date: Feb. 7, 2008

(54) System and method for determining unimportant probe locations by examination of byte code to identify method by name pattern

(76) Inventors: Howard M. McKinney, Austin, TX (US); Kirk M. Sexton, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/477,735

(22) Filed: Jun. 29, 2006

(51) Int. Cl. G06F 9/44

(52) U.S. Cl. 717/130

(57) ABSTRACT

A method, system, and computer-usable medium for determining unimportant probe locations by examination of byte code to identify method by name pattern. In a preferred embodiment of the present invention, a first candidate location is identified in byte code to instrument with a monitoring probe. The first candidate location is screen according to a list of ineligible method names and/or property names. Responsive to a match with the list, the first candidate location is eliminated as a byte code location to instrument.

### CROSS REFERENCE TO RELATED APPLICATIONS

The present application is related to the following co-pending U.S. Patent Applications: U.S. patent application Ser. No. 10/809,580 (Docket No. AUS920040049US1) filed on Mar. 25, 2004; and U.S. patent application Ser. No. 10/971,473 (Docket No. AUS920040382US1) filed on Oct. 22, 2004. The above-mentioned patent applications are assigned to the assignee of the present invention and are incorporated herein by reference in their entirety.

### BACKGROUND OF THE INVENTION

1. Technical Field

The present invention relates in general to the field of data processing systems. More specifically, the present invention relates to the field of measuring performance metrics of data processing systems.

2. Description of the Related Art

In large computer system, such as those providing online information and services to clients, it is vital to be able to monitor transactions through a complex system, which can contain multiple computers, connections, and software programs. Such monitoring can be used to detect which specific areas are causing problems or slowdowns and to ensure that a contracted level of service is provided. However, the monitoring programs themselves can potentially use large amounts of overhead, so that it is necessary to minimize this overhead whenever possible.

Java is an object-oriented programming language that is platform independent, so that Java programs can run on virtually every system. A Java Virtual Machine (JVM) resides on a computer system and compiles Java programs from a platform-independent form to a machine-specific form for the machine on which it is installed. The JVM has the ability to interface with a monitoring agent such that when a Java class is complied by the JVM, the monitoring agent can inject special byte-codes in the in-memory application. These byte-codes include runtime hooks that contain the logic to manage the execution of components of the monitoring programs called probes. When a hook is triggered, it gets the list of probes currently enabled for its location from a registry belonging to the monitoring agent and executes the probes. It is neither necessary nor generally desirable to monitor each and every transaction that passes through the system. Instead, mechanisms re provided to select a percentage of the transactions, such as 5%, 10%, or 20%. However, the information to determine whether or not to execute a probe is not available until a probe has been started. If there is a large amount of information that must be passed to the probe or when the probe is executed many times, a large amount of overhead is incurred. There is a need for a system and method for identifying unnecessary probe locations to reduce the amount of overhead incurred.

### SUMMARY OF THE INVENTION

The present invention includes a method, system, and computer-usable medium for determining unimportant probe locations by examination of byte code to identify method by name pattern. In a preferred embodiment of the present invention, a first candidate location is identified in byte code to instrument with a monitoring probe. The first candidate location is screen according to a list of ineligible method names and/or property names. Responsive to a match with the list, the first candidate location is eliminated as a byte code location to instrument.

The above, as well as additional purposes, features, and advantages of the present invention will become apparent in the following detailed description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 illustrates an exemplary network in which a preferred embodiment of the present invention may be implemented;

FIG. 2 depicts an exemplary server in which a preferred embodiment of the present invention may be implemented;

FIG. 3 illustrates a relationship between a Java Virtual Machine (JVM), a monitoring agent, and a transaction running on a system according to a preferred embodiment of the present invention; and

FIG. 4 is a high-level logical flowchart depicting an exemplary method for determining unimportant probe locations by examination of byte code to identify method by name pattern according to a preferred embodiment of the present invention.

### DETAILED DESCRIPTION OF A PREFERRED EMBODIMENT

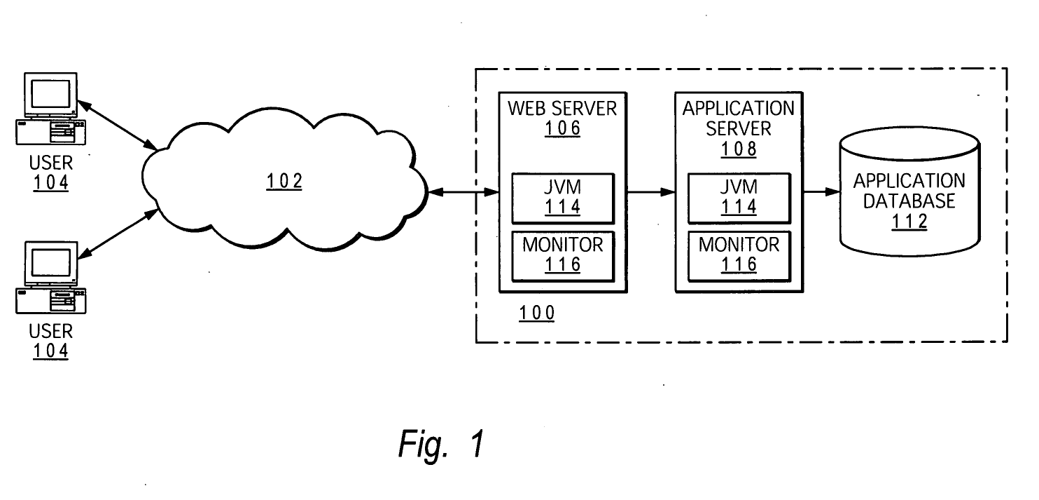

With reference to FIG. 1, a computer system 100 for a business entity is connected to the Internet 102 in order to provide computer services online. The website of the business entity is accessible to various online users 104.

In the presently preferred embodiment, Java 2 Platform Enterprise Edition (J2EE) is used on computer system 100. J2EE is a platform-independent, JAVA-centric environment from Sun Microsystems for developing, building and deploying Web-based enterprise applications online. The J2EE platform consists of a set of services, APIs, and protocols that provide the functionality for developing multitiered, Web-based applications. At the client level, J2EE supports pure HTML, as well as Java applets or applications. Enterprise JavaBeans (EJBs) provide another layer where the platform's logic is stored. Within computer system 100, Web server 106 is configured to communicate over the Internet, as well as within the intranet of system 100; application server 108 is only connected to communicate within the intranet, but can access application database 112. In addition to other programs and processes that exist on these servers, each of server 106, 108 contains a copy of Java Virtual Machine (JVM) 114 and monitoring program 116, which will be discussed further below. One of ordinary skill in the art will recognize that many other configurations are possible in the disclosed intranet. For example, the web server and the application server can be on a single machine. Conversely, there may be a number of both web servers and application servers; there may also be separate database servers if the situation required it.

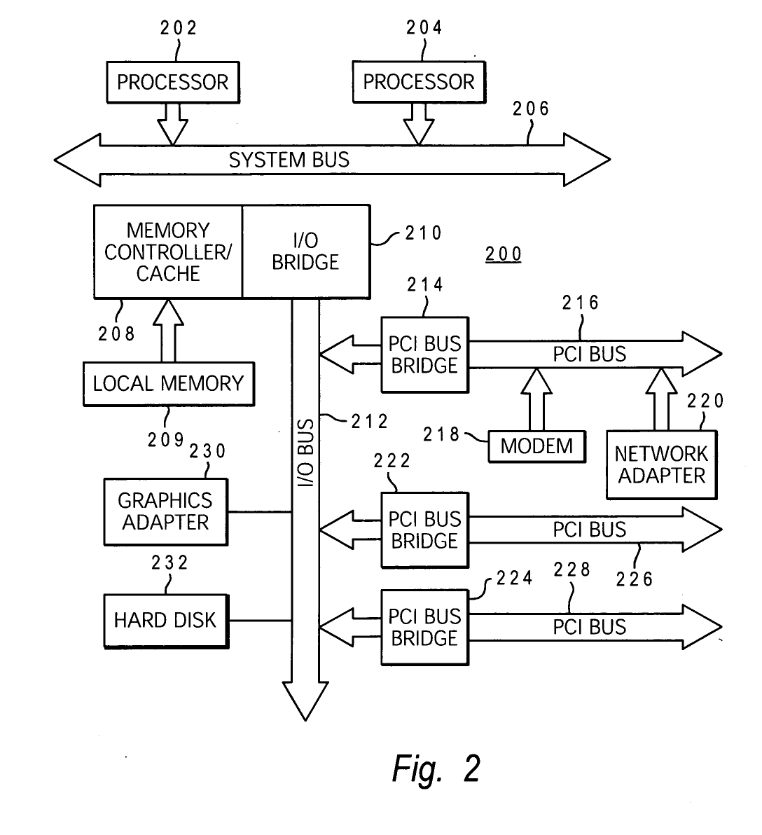

Referring to FIG. 2, a block diagram of a data processing system that may be implemented as a server, such as servers 106, 108 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to users 104 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

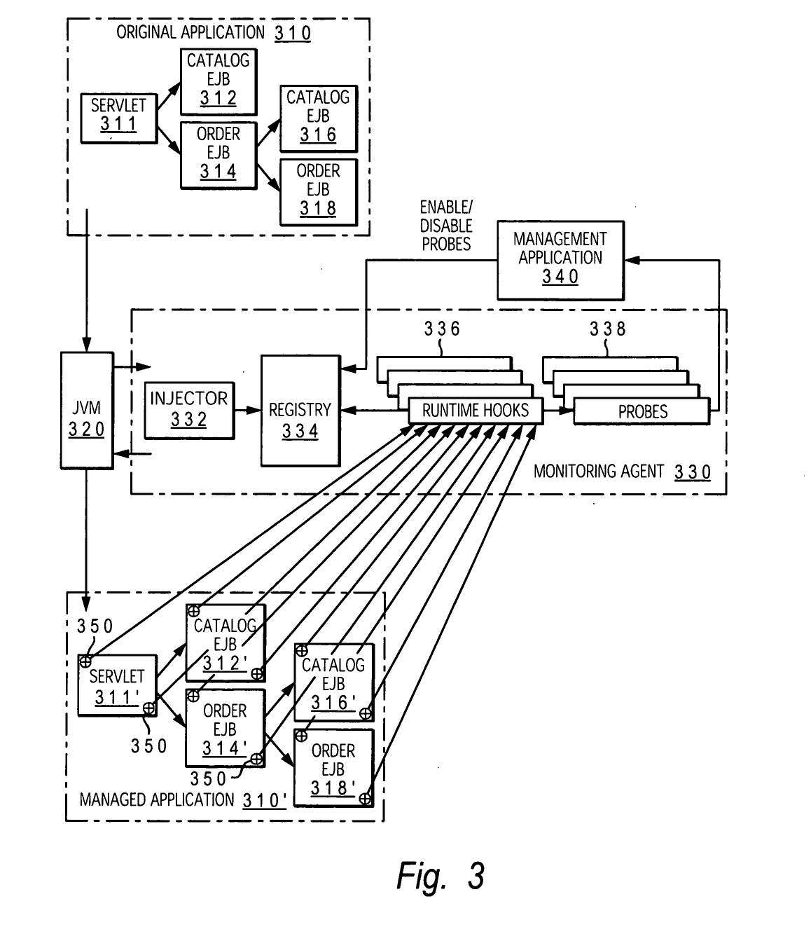

With reference to FIG. 3, an overview the relationship between an application 310, a copy of the Java Virtual Machine (JVM) 320 and a monitoring agent 330 is shown. A bi-directional interface exists between JVM 320 and monitoring agent 330. Monitoring agent 330 contains injector 332 (which injects byte codes or hooks into applications), registry 334 (which contains a registry of all enabled probes), hooks 336 (which contain the logic to manage the execution of probes), and probes 338. Probes can be enabled or disabled by management application 340. Exemplary application 310 contains servlet 311, which invokes Enterprise JavaBeans (EJBs) 312, 314. In turn EJB 314 invokes further EJBs 316, 318. When application 310 is compiled by the JVM, the interface between JVM 320 and monitoring agent 330 allows injector 332 to inject special byte codes 350 into the components 311, 312, 314, 316, 318 of application class 310 to form managed application 310′. Note that each of the components 311′, 312′, 314′, 316′, 318′ of managed application 310′ contains inserted byte codes 350. These byte codes 350 correspond to hooks 336; when managed application 310′ executes, hooks 336 will interface with registry 334 and cause the desired probes 338 to execute.

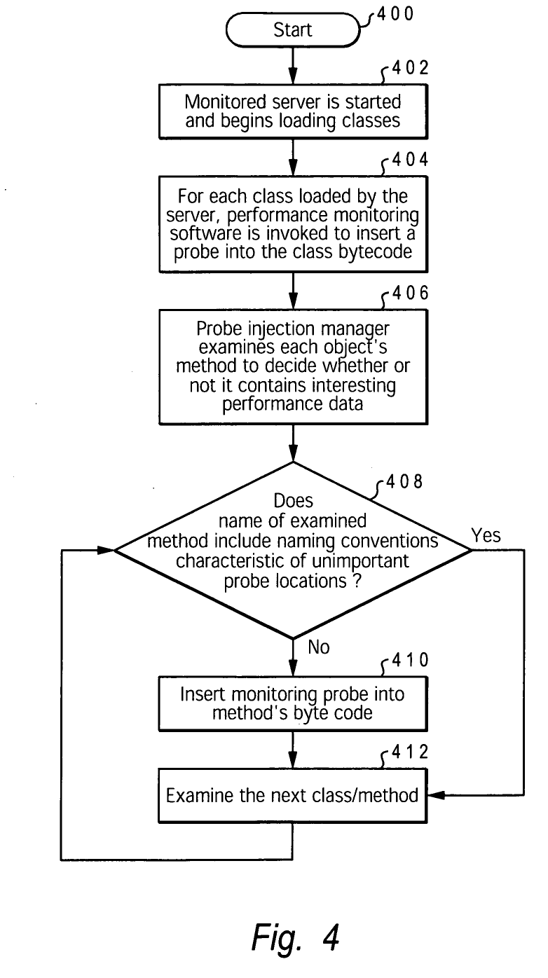

FIG. 4 is a high-level logical flowchart diagram illustrating an exemplary method for determining unimportant probe locations by examination of byte code to identify method by name pattern according to a preferred embodiment of the present invention. The process begins at step 400 and proceeds to step 402, which illustrates the startup of computer system 100 and the loading of classes. The process continues to step 404, which depicts computer system 100 invoking management application 340 to insert probes into the class byte code of each class loaded. The process continues to step 406, which illustrates management application 340 examining each object's method to determine if the method includes performance data of interest to management application 340.

The process proceeds to step 408, which illustrates management application 340 determining if the name of the currently-examined method include naming conventions characteristic of unimportant probe locations for the purposes of measuring performance data. In a preferred embodiment of the present invention, management application 340 dynamically detects certain characteristics of the target method before inserting instrumentation code. One preferred type of unimportant probe locations is know as the getter/setter method (also known as accessor/mutator methods)/ These accessor/mutator methods are commonly utilized to provide access to information encapsulated in an object.

Most getter/setter methods follow common naming conventions utilized by most Java programmers. These method names often begin with “get”, “is”, or “has” for accessor methods, and “set” for mutator methods. The values that these methods manipulate are referred to as “properties”, which are often private object level variables. For example, an object that has a private property named “customerName” could have a set of accessor/mutator methods correspondingly named “setCustomerName” and “getCustomerName”. By convention, these methods would be only responsible for getting and setting values of the “customerName” variable.

At the time when management application 340 is examining a probe location, these method names can be examined and compared against the object fields. If a method name is found that conforms to this design patter (e.g., the method name starts with “get”, “is”, “has” or “set”, and there exists an object variable with the same name as the rest of the method name), then the method is deemed unimportant and will not be instrumented by management application 340. Those with skill in the art will appreciate that the present invention is not limited to identifying getter/setter methods or the Java language, but is applicable to any identification of unimportant methods utilizing name patterns.

If the name of the examined method includes naming conventions characteristic of unimportant probe locations, the process continues to step 412. If the name of the examined method does not include naming conventions characteristic of unimportant probe locations, the process continues to step 410, which depicts management application 340 inserting a monitoring probe (e.g., probes 338) into the method's byte code. The process proceeds to step 412, which illustrates management application 340 examining the next class/method in application 310. The process returns to step 408 and proceeds in an iterative fashion.

As discussed, the present invention includes a method, system, and computer-usable medium for determining unimportant probe locations by examination of byte code to identify method by name pattern. In a preferred embodiment of the present invention, a first candidate location is identified in byte code to instrument with a monitoring probe. The first candidate location is screen according to a list of ineligible method names and/or property names. Responsive to a match with the list, the first candidate location is eliminated as a byte code location to instrument. It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks, including Ethernet, the Internet, wireless networks, and like network systems. It should be understood, therefore, that such signal-bearing media when carrying or encoding computer readable instructions that direct method functions in the present invention represent alternative embodiments of the present invention. Further, it is understood that the present invention may be implemented by as a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as utilized in the specification and the appended claims, the term “computer” or “system” or “computer system” or “computing device” includes any data processing system including, but not limited to, personal computers, servers, workstations, network computers, main frame computers, routers, switches, personal digital assistants (PDAs), telephones, and any other system capable of processing, transmitting, receiving, capturing, and/or storing data.

What is claimed is:

1. A method for selecting monitor locations for monitoring a data processing system, said method comprising:
identifying a first candidate location in byte code to instrument with a monitoring probe;
screening said first candidate location according to a list of ineligible method names and/or property names; and
responsive to a match with said list, eliminating said first candidate location as a byte code location to instrument.

2. The method according to claim 1, further comprising:
invoking an management application to insert a probe into said byte code location.

3. The method according to claim 1, wherein said list includes “get”, “is”, “has”, and “set”.

4. The method according to claim 1, wherein said first candidate location is a getter/setter method.

5. A system for selecting monitor locations for monitoring a data processing system, said system comprising:
a processor;
a databus coupled to said processor;
a computer-usable medium embodying computer program code, said computer-usable medium being coupled to said databus, said computer program code comprising instructions executable by said processor and configured for:
identifying a first candidate location in byte code to instrument with a monitoring probe;
screening said first candidate location according to a list of ineligible method names and/or property names; and
responsive to a match with said list, eliminating said first candidate location as a byte code location to instrument.

6. The system according to claim 5, wherein said instructions are further configured for:
invoking an management application to insert a probe into said byte code location.

7. The system according to claim 5, wherein said list includes “get”, “is”, “has”, and “set”.

8. The system according to claim 5, wherein said first candidate location is a getter/setter method.

9. A computer-usable medium embodying computer program code, said computer program code comprising computer-executable instructions configured for:
identifying a first candidate location in byte code to instrument with a monitoring probe;
screening said first candidate location according to a list of ineligible method names and/or property names; and
responsive to a match with said list, eliminating said first candidate location as a byte code location to instrument.

10. The computer-usable medium according to claim 9, wherein said embodied computer program code further comprises computer-executable instructions configured for:
invoking an management application to insert a probe into said byte code location.

11. The computer-usable medium according to claim 9, wherein said list includes “get”, “is”, “has”, and “set”.

12. The computer-usable medium according to claim 9, wherein said first candidate location is a getter/setter method.
